(19) United States
(12) Patent Application Publication
(10) Pub. No.: US 2010/0308103 A1
(43) Pub. Date: Dec. 9, 2010

(54) SYSTEM AND METHOD FOR VAPOR PHASE REFLOW OF A CONDUCTIVE COATING

(75) Inventors: GEORGE JYH-SHANN CHOU, MECHANICSBURG, PA (US); ROBERT DANIEL HILTY, HARRISBURG, PA (US)

Correspondence Address: ROBERT J. KAPALKA;TYCO TECHNOLOGY RESOURCES, 4550 NEW LINDEN HILL ROAD, SUITE 140, WILMINGTON, DE, 19808, US

(73) Assignee: TYCO ELECTRONICS CORPORATION, BERWYN, PA (US)

(21) Appl. No.: 12/480,046

(22) Filed: Jun. 8, 2009

(51) Int. Cl. B23K 31/02; B23K 37/04; B23K 37/00

(52) U.S. Cl. 228/125; 228/49.5; 228/18

(57) ABSTRACT

A system for manufacturing electrical components includes a reflow chamber having an inlet port and an outlet port. The inlet port receives a web of interconnected electrical components having a conductive coating into the reflow chamber. The outlet port discharges the web from the reflow chamber. The reflow chamber directs the web of interconnected electrical components along a predetermined pathway through the reflow chamber. The reflow chamber retains a heated and saturated vapor to heat the conductive coating as the web passes along the pathway through the chamber to reflow the conductive coating about the electrical components.

### BACKGROUND OF THE INVENTION

This invention relates generally to manufacturing methods and apparatus for electrical components, and more particularly, to methods and systems for vapor phase reflowing of electrical components.

Some known electrical and electronic devices include circuitry and components which are electrically coupled to operate the devices. Typically, the circuitry includes electrical contacts that are mechanically attached, surface mounted and/or soldered to a circuit board. A substrate material of each of the electrical contacts may be plated with a conductive coating to enhance the soldering characteristics of the electrical contacts. Tin and tin alloy coatings have been used to coat substrate materials due to the low cost, anti-corrosion, and solderability properties of the tin and tin alloy coatings.

But, tin and tin alloy coatings have the problems of tin whisker growth and poor solderability due to reactions between the tin and the substrate material. To overcome the problems of tin whiskering and poor solderability, the tin coating may be heated until the tin is reflowed about the exterior of the electronic components. The benefits of the reflowed tin result from microstructure changes and stress relief in the coating and substrate material. One known process used to reflow the conductive coatings involves the use of a reflow oven to heat the electrical contact and the tin coating. One type of reflow oven is a convection oven. Another type of reflow oven is an infrared heating oven. These ovens may be relatively inefficient and slow to heat and reflow the conductive coatings. Additionally, once the electrical components are removed from the oven, the components may be further shaped, stamped or trimmed to a final form, thus exposing the substrate material on areas of the contact such as the edges. The exposed substrate may cause solderability problems during assembly of the electrical device.

Another known process used to reflow the conductive coatings involves inductively heating the plated electrical components. The inductive heating process may include passing the plated components near heating elements or coils to heat and reflow the coatings. Due to the complex shape of some plated components, however, evenly heating the entirety of the coatings may be difficult or impossible. For example, some portions of the components may be overheated relative to other portions of the components. Specially tailored heating elements or coils and tuning the induction system may be required to rapidly heat sections of components having complex shapes or relatively high thermal masses. The use of specially tailored coils and tuning for the parts of significant geometry add to the complexity of systems used to manufacture the components. Moreover, components with complex shapes may be difficult to rapidly and evenly heat the conductive coatings. If the time required to tailor coils and to tune the induction system for reflowing the coatings increases, the time required to complete manufacture of the electronic components also may increase. In some instances, the plated electrical components are inductively heated in an atmosphere containing oxygen. The coatings and/or the underlying stock material of the components may be oxidized and corroded when heated in the atmosphere. Additionally, the use of induction coil to heat the electrical component coatings may result in radio frequency interference with electronic controller in conveyance system. Due to the relatively large amount of electric current required to heat the inductive elements or coils, the inductive heating elements can pose a safety risk to operators of the manufacturing system.

### BRIEF DESCRIPTION OF THE INVENTION

In one embodiment a system for manufacturing electrical components is provided. The system includes a reflow chamber having an inlet port and an outlet port. The inlet port receives a web of interconnected electrical components having a conductive coating into the reflow chamber. The outlet port discharges the web from the reflow chamber. The reflow chamber directs the web of interconnected electrical components along a predetermined pathway through the reflow chamber. The reflow chamber retains a heated vapor to heat the conductive coating as the web passes along the pathway through the chamber to reflow the conductive coating about the electrical components. The reflow chamber is shaped to collect condensation of the heated vapor and the heating element is configured to heat the condensation to generate additional heated vapor. In one embodiment, the system includes a plating station that provides the conductive coating on the electrical components prior to passing the electrical components through the reflow chamber.

In another embodiment, a method for manufacturing electrical components is provided. The method includes providing a web of interconnected electrical components having a conductive coating and moving the web through a reflow chamber. The conductive coating on the electrical components is heated in the reflow chamber using a heated vapor to reflow the conductive coating about the electrical components. Optionally, the method may include cooling the conductive coating after the web passes through the reflow chamber to at least one of remove vapor condensation from the web and solidify the conductive coating.

In another embodiment, another method for manufacturing electrical components is provided. The method includes passing a continuous web of interconnected electrical components through a reflow chamber. The electrical components have a conductive coating that is heated in the reflow chamber with a heated vapor to reflow the conductive coating about the electrical components. Alternatively, the web includes electrical contacts interconnected by a carrier strip.

### BRIEF DESCRIPTION OF THE DRAWINGS

FIG. 1 is a schematic view of a system used to manufacture electrical components in accordance with one embodiment.

FIG. 2 is a schematic view of a vapor phase reflow chamber shown in FIG. 1 and implemented in accordance with one embodiment.

FIG. 3 is an elevational view of the vapor phase reflow chamber shown in FIG. 1 and formed in accordance with another embodiment.

FIG. 4 is a schematic view of a vapor phase reflow chamber implemented in accordance with another embodiment.

FIG. 5 is a flowchart of a method for reflowing a conductive coating on formed electrical components according to one embodiment.

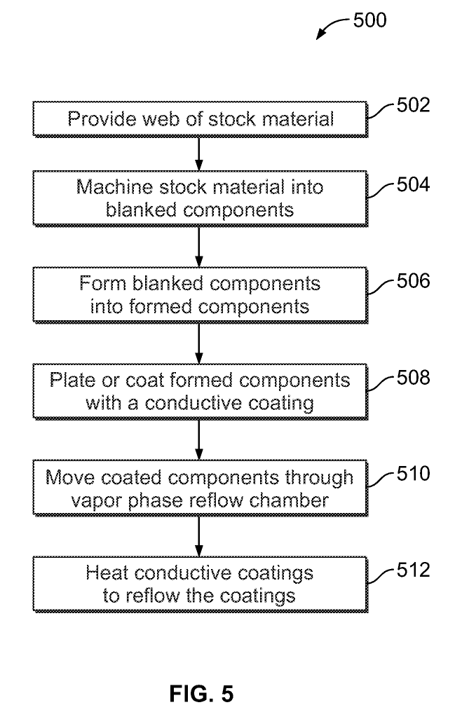

### DETAILED DESCRIPTION OF THE INVENTION

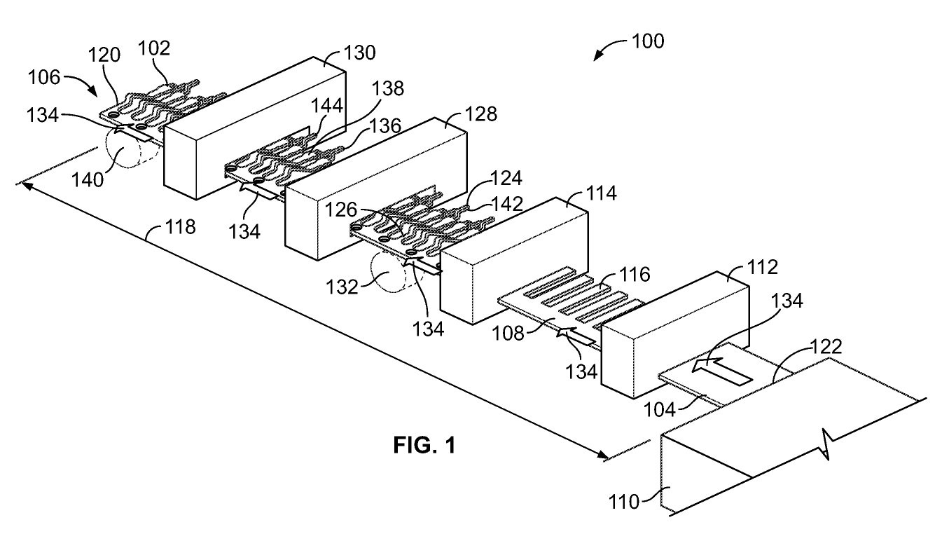

FIG. 1 is a schematic view of a system 100 used to manufacture end-usable electrical components 102 in accordance with one embodiment. The electrical components 102 are fabricated from a conductive material (for example, copper, aluminum, steel, or the like) or from a dielectric material (for example, a polymer or ceramic material) and at least partially coated with a conductive material. The electrical components 102 are transformed or otherwise manipulated by the system 100 from a stock material 104. The stock material 104 is a planar body of conductive material having predefined width, length and thickness dimensions in the illustrated embodiment. The electrical components 102 include end-usable components such as electrical contacts, for example.

The system 100 includes a conveyance system 110 for moving the electrical components 102 through the system 100. The system 100 moves the electrical components 102 as a continuous web 106 of electrical components 102. The continuous web 106 includes a finite length 118 of electrical components 102 interconnected with one another by a carrier strip 108. The length 118 of the web 106 extends from one end 120 of the web 106 to an opposite end 122. The conveyance system 110 moves the web 106 along a predetermined processing pathway 134 that extends through several stations or chambers 112, 114, 128, 130. The direction of the pathway 134 is indicated using arrows in FIG. 1 and generally extends along the path that the web 106 is translated or moved through the stations and chambers 112, 114, 128, 130.

The system 100 manufactures the electrical components 102 from the stock material 104 using several manufacturing processes or operations. The operations described herein are merely provided as examples and are not intended to encompass all potential operations used to manufacture the electrical components 102. In one embodiment, the system 100 includes a stamping station 112 and a forming station 114 to facilitate the shaping of the item electrical components 102. The stock material 104 is moved to the stamping station 112 by the conveyance system 110 where the stock material 104 is pressed, blanked or machined into blanked components 116. For example, a portion of the stock material 104 is removed such that the blanked components 116 are interconnected along the carrier strip 108 in a series along the length 118 of the web 106. During the stamping operation, a portion of the stock material 104 may be subject to shear forces.

The blanked components 116 are then conveyed to the forming station 114. At the forming station 114, the blanked components 116 are formed or shaped into formed electrical components 124. The formed electrical components 124 have a predetermined shape. For example, the formed electrical components 124 may be curved or flexed into a certain non-planar pattern. The forming station 114 may perform a pressing operation to create the formed electrical components 124 using dies and a pressing machine to provide the curved or flexed pattern of the formed electrical components 124. Alternatively, the forming station 114 may perform a crimping operation to provide the non-planar pattern of the formed electrical components 124. Once formed, the formed electrical components 124 extend between a base 126 and a tip 142. Each base 126 is connected to the carrier strip 108 such that the formed electrical components 124 are interconnected with one another. Alternatively, rather than providing stamped and formed electrical contacts, the forming station 114 may include a molding or casting station that molds or casts the formed electrical components 124.

The formed electrical components 124 have a substantially similar shape as the end-usable electrical components 102. The formed electrical components 124 are then conveyed or otherwise provided to a plating station 128 and then a vapor phase reflow chamber 130. In one embodiment, additional shaping and forming of the formed electrical components 124 is not required after the formed electrical components 124 are provided to and processed by the plating station 128 and the reflow chamber 130. Optionally, the formed electrical components 124 are wound onto a reel 132 prior to being conveyed to the plating station 128. Alternatively, the reel 132 may be positioned downstream of the plating station 128 along the pathway 134 and the formed electrical components 124 may be wound onto the reel 132 after the formed electrical components 124 are conveyed to the plating station 128 but before the formed electrical components 124 are conveyed to the reflow chamber 130. Two or more of the processes may be performed using different systems 100, and the reels 132 may be provided to the plating station 128 or passed through the reflow chamber 130 as needed. Alternatively, the formed electrical components 124 are conveyed directly from the forming station 114 to the plating station 128 and then to the reflow chamber 130.

At the plating station 128, the formed electrical components 124 are plated or coated with a conductive coating 138 to form plated electrical components 136. For example, the formed electrical components 124 may be at least partially coated with tin (Sn) or a conductive alloy that includes tin. Alternatively, the conductive coating 138 is a gold (Au) or gold alloy coating. However, other coatings 138 may also be used. The conductive coating 138 on the plated electrical components 136 is in a plated state prior to passing the components 136 through the reflow chamber 130. In the plated state, the coating 138 has been applied to the formed components 124 without heating or re-heating the coating 138 to cause the coating 138 to flow about the formed electrical components 124. A single coating 138 or a plurality of coatings 138 may be applied to the formed electrical components 124. The coating 138 facilitates enhancing the soldering and electrical characteristics of the electrical components 102. The conductive coating 138 is applied through a plating process performed by the plating station 128. Alternatively, the conductive coating 138 may be applied through one or more of a dipping process, a spraying process, and the like. In one embodiment, the entire formed electrical component 124 is coated. Optionally, the formed electrical component 124 may be coated in pre-selected areas.

Because the plated electrical components 136 are formed and shaped prior to plating at the plating station 128, the coating 138 is less susceptible to being damaged or removed. For example, bending or shearing forces imparted on the plated electrical components 136, and particularly the coating 138, causes at least a portion of the coating 138 to weaken or flake, thus exposing the underlayer of stock material 104. The exposure of the underlayer causes solderability problems due to corrosion of the stock material 104 during a subsequent process where the electrical components 102 are assembled to a plastic housing and soldered to circuit board. One area particularly susceptible to this weakening or flaking of the stock material 104 is edges 144 of the plated electrical components 136. By reducing or substantially eliminating any bending or manipulating of the shape of the plated electrical components 136 after plating at the plating station 128, but before a reflow operation is applied to the coating 138 at the reflow chamber 130, the weakening of the coating 138 is reduced or substantially eliminated. After coating, the plated electrical components 136 are transferred to the reflow chamber 130.

At the reflow chamber 130, the plated electrical components 136 are heat treated through a vapor phase reflow process to convert the coating 138 from a plated state to a reflowed state. The reflow process heats the conductive coating 138 to a sufficiently high temperature using a heated and saturated vapor such that the coating 138 flows about the electrical components 124. For example, the reflow process may heat a conductive coating 138 that includes tin (Sn), a tin alloy, zinc (Zn) or a zinc alloy to, at least, above the melting temperature of conductive coating (e.g. approximately 232 degrees Celsius for pure tin). Alternatively, the reflow process heats the conductive coating 138 that includes tin (Sn) or a tin alloy to at least approximately 260 degrees Celsius for tin coating. Alternatively, a different heating temperature may be used. By way of example only, the reflow process may heat the conductive coating 138 to approximately 240 degrees Celsius. The coating 138 is reflowed to alter microstructures in the coating 138 and to relieve internal stresses in the coating 138. Such internal stresses may result in cracking in the coating 138 and/or delamination of the coating 138 from the formed electrical components 124.

The reflow process heats the coating 138 using an inert gas to avoid oxidizing or otherwise corroding the formed electrical components 124. Additionally, the use of a heated gas to reflow the coating 138 may result in a more even heating of relatively complex shapes of the plated electrical components 136. For example, the heated gas may avoid over- or underheating portions of the components 136. The reflow process may heat the conductive coating 138 to the melting temperature of the conductive coating 138 but below the melting temperature of the stock material 104. In one embodiment where multiple coatings 138 are applied to the formed electrical components 124, the reflow process heats the coatings 138 to a temperature that is sufficiently high to reflow one of the coatings 138, but is low enough to avoid reflowing another one of the coatings 138. For example, the coatings 138 may include an inner coating of gold (Au) or a gold alloy and an outer coating of tin (Sn) or a tin alloy. The coatings 138 may be heated to a temperature of at least approximately 232 degrees Celsius in order to reflow the outer coating without melting or reflowing the inner coating.

Heating the conductive coating 138 in order to reflow the coating 138 relieves internal stresses in the coating 138. Variations in the concentrations of the materials forming the coating 138 can cause or contribute to internal stresses in the coating 138. For example, where an alloy is used for the coating 138, a larger concentration of one alloy material in a portion of the coating 138 may introduce stress in the coating 138 at the interfaces between the portions of the coating 138 having different concentrations of the alloy material. The reflow of the coating 138 also eliminates or avoids leaving any whiskers that have formed on the coating 138 from remaining after heating the coating 138. For example, any whiskers or other growths in the coating 138 that are present before heating the coating 138 may be heated to reflow the material forming the whiskers and thus eliminate the whiskers. The coating 138 may flow and more evenly distribute the alloy materials throughout the coating 138.

The conveyance system 110 moves the web 106 through the reflow chamber 130 such that the reflow chamber 130 heats and reflows the conductive coatings 138 in a continuous manner. For example, the system 100 may pass the web 106 through the reflow chamber 130 such that less than the entirety of the web 106 is located within or treated by the reflow chamber 130 at a given time. The number of formed electrical components 124 that may be located in the reflow chamber 130 at a given time may vary based on the size of the reflow chamber 130, the size of the formed electrical components 124, and the spacing between the formed electrical components 124 in the web 106, for example. Downstream portions of the web 106 pass through the reflow chamber 130 prior to upstream portions of the web 106. The web 106 may be passed through the reflow chamber 130 along the pathway 134 at an approximately constant speed until the entire length 118 or approximately the entire length 118 of the web 106 has passed through the reflow chamber 130 and the conductive coatings 138 on the formed electrical components 124 of the web 106 have been reflowed about the formed electrical components 124. In one embodiment, the web 106 passes through the reflow chamber 130 at a speed by which each formed electrical components 124 is located within the reflow chamber 130 for approximately two seconds.

The speed at which the web 106 is moved through the reflow chamber 130 may be varied to match the speed at which the web 106 moves through the other stations 112, 114, 128 of the system 100. In one embodiment, the web 106 may be moved along the pathway 134 and through the reflow chamber 130 at a speed of between approximately three to approximately 350 linear feet of web 106 per minute. In another embodiment, the web 106 moves through the reflow chamber 130 at a greater speed. Moving the web 106 through the reflow chamber 130 as the coatings 138 are heated in the chamber 130 may permit multiple stations 112, 114, 128 of the system 100 or the entire system 100 to manufacture the end-usable electrical components 102 in a continuous process as opposed to a batch process.

The reflow process may initiate a chemical reaction between two or more conductive coatings 138 on the formed electrical components 124 and/or between a conductive coating 138 and the stock material 104 of the formed electrical components 124. The reaction may include the formation of intermetallic compounds which increase the effective hardness of the coating 138 and further reduce the potential for whisker growth of the coating 138 or eliminate existing whiskers in the coating 138. Additionally, the reaction may cause the metals in the coating 138 and/or formed electrical components 124 to achieve higher levels of stress-resistance to surface deformation, which also relieves internal stresses and whiskering.

Once the plated electrical components 136 are heat treated at the reflow chamber 130, the electrical components 102 are in an end-usable form. For example, the electrical components 102 may be detached from the carrier strip 108 and used in an electrical connector (not shown) or circuit board (not shown). Optionally, the electrical components 102 may be cooled or cured after being heat treated. The electrical components 102 may be wound on a reel 140 for storing or transporting the electrical components 102.

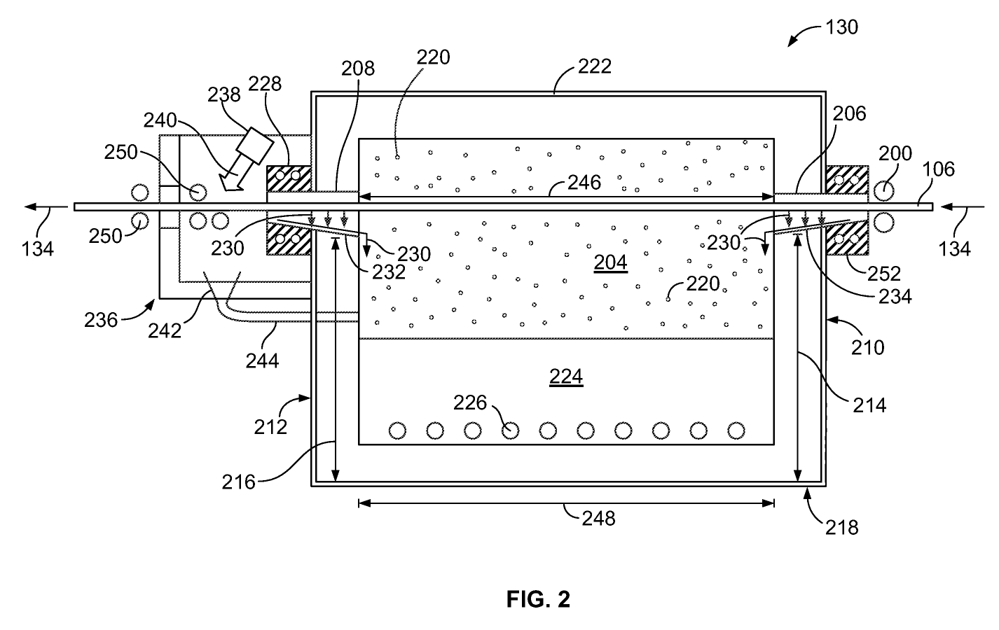

FIG. 2 is a schematic view of the vapor phase reflow chamber 130 implemented in accordance with one embodiment. As described above, the web 106 of interconnected and plated electrical components 136 (shown in FIG. 1) passes through the reflow chamber 130 along the pathway 134. The conveyance system 110 (shown in FIG. 1) introduces the web 106 into an interior chamber 204 of the reflow chamber 130 through an inlet port 206. The inlet port 206 may be shaped and sized to accept plated electrical components 136 of a variety of shapes and sizes. The reflow chamber 130 directs the web 106 through the interior chamber 204 along the pathway 134 and discharges the web 106 out of the reflow chamber 130 via an outlet port 208. Similar to the inlet port 206, the outlet port 208 may be sized and shaped to accept plated electrical components 136 of a variety of shapes and sizes. In the illustrated embodiment, the inlet and outlet ports 206, 208 are disposed on opposite sides 210, 212 of the reflow chamber 130. Alternatively, the inlet and outlet ports 206, 208 may be located on sides of the chamber 130 that are not opposite of one another, or sides that intersect one another at an edge. The inlet and outlet ports 206, 208 in the reflow chamber 130 shown in FIG. 2 are approximately equal heights 214, 216 above a bottom side 218 of the chamber 130. As a result, the pathway 134 through the reflow chamber 130 is approximately level such that the web 106 is approximately level as the web 106 passes through the interior chamber 204. Optionally, the pathway 134 may have a tortuous path through the interior chamber 204 from the inlet port 206 to the outlet port 208 to increase the length of time that the plated electrical components 136 are in the chamber 130, otherwise known as the dwell time for the plated electrical components 136. For example, the inlet and outlet ports 206, 208 may be disposed such that the web 106 enters the reflow chamber 130 through the inlet port 206, moves along an indirect route within the reflow chamber 130 between the inlet and outlet ports 206, 208, and passes out of the reflow chamber 130 through the outlet port 208.

The conveyance system 110 (shown in FIG. 1) includes inlet and outlet wheels 200, 250 that move the web 106 through the reflow chamber 130. For example, the inlet wheels 200 may be disposed along the pathway 134 upstream of the inlet port 206 while the outlet wheels 250 may be disposed along the pathway 134 downstream of the outlet port 208. The wheels 200, 250 may engage the web 106 to translate the web 106 along the pathway 134. In one embodiment, the wheels 200, 250 move the web 106 without touching the plated electrical components 136 (shown in FIG. 1). For example, the wheels 200, 250 engage the carrier strip 108 (shown in FIG. 1) to avoid contacting the conductive coating 138.

A heated and saturated vapor 220 may be generated by heating fluorinated fluid in the reservoir 224 using heating elements 226 and retained in the interior chamber 204 to heat the conductive coating 138 on the plated electrical components 136 (shown in FIG. 1) and reflow the coating 138 about the components 136. The conveyance system 110 moves the web 106 through the interior chamber 204 in order to heat the plated electrical components 136 disposed along the length 118 (shown in FIG. 1) of the web 106. As shown in FIG. 2, the entire length 118 of the web 106 is not located in the interior chamber 204 at a single time. Instead, a section length 246 of the web 106, which is less than the length 118, is disposed in the interior chamber 204. The section length 246 may be approximately the same as a separation dimension 248 that separates the inlet and outlet ports 206, 208 and that is measured along the bottom side 218 of the reflow chamber 130. The conveyance system 110 may continually move the web 106 through the interior chamber 204 such that the entire length 118 may be heated.

The vapor 220 is heated to a temperature that is sufficiently high to reflow the conductive coating 138 (shown in FIG. 1) on the plated electrical components 136 (shown in FIG. 1) as the web 106 passes through the reflow chamber 130. For example, the vapor 220 may be heated to a temperature of at least approximately 240 degrees Celsius. Alternatively, the vapor 220 may be heated to a temperature of at least approximately 260 degrees Celsius where tin (Sn) or a tin alloy is included in the conductive coatings 138. The reflow chamber 130 includes insulation 222 that substantially encloses the entire interior chamber 204 in order to assist with maintaining the temperature of the heated and saturated vapor 220. In the illustrated embodiment, the interior chamber 204 includes a reservoir 224 of fluorinated liquid that is heated to generate the heated vapor 220. The fluorinated liquid is heated by a heating element 226 located in the reservoir 224. For example, resistive heating elements that are encompassed by the liquid in the reservoir 224 may be powered to heat the liquid in the reservoir 224 and convert the liquid into a vapor phase to generate the heated vapor 220. The liquid in the reservoir 224 may be heated to a sufficiently high temperature that the atmosphere of the interior chamber 204 is saturated with the vapor 220

The liquid may be a material that creates an inert gas vapor when heated. For example, the liquid includes fluorinated ether in one embodiment. Creating an inert gas vapor can reduce the oxidation or corrosion of the stock material 104 (shown in FIG. 1) in the plated electrical components 136 during reflow of the coating 138. Alternatively, the heated vapor 220 may be communicated to the interior chamber 204 through an inlet (not shown) similar to the inlet port 206. For example, a pump (not shown) may force a heated vapor 220 that is supplied from outside of the interior chamber 204 into the interior chamber 204.

The use of the heated and saturated vapor 220 to heat and reflow the coating 138 may provide an approximately even temperature distribution in the interior chamber 204. An even temperature distribution in the interior chamber 204 may more evenly heat the entire coating 138. Evenly heating the coating 138 prevents different portions of the coating 138 (shown in FIG. 1) of the plated electrical components 136 (shown in FIG. 1) from receiving different thermal energies from the vapor 220. An uneven distribution of thermal energy that is applied to the coating 138 on a plated electrical component 136 may result in an uneven reflow of the coating 138 about the component 136. An uneven reflow of the coating 138 can introduce, rather than reduce, internal stresses in the coating 138 or between the coating 138 and the stock material 104 (shown in FIG. 1) that underlies the coating 138. Additionally, using the heated and saturated vapor 220 to heat the plated electrical components 136 allows the same reflow chamber 130 to be used to reflow the conductive coating 138 on a variety of different plated electrical components 136. For example, the even heating of the heated and saturated vapor 220 on the plated electrical components 136 permits the same reflow chamber 130 to be used to heat treat electrical contacts with different geometries, wires, and the like.

Reflowing the conductive coatings 138 (shown in FIG. 1) with heated and saturated vapor 220 provides the ability to quickly heat the conductive coatings 138. The heated vapor 220 can have a relatively high heat capacity when compared to the plated electrical components 136 (shown in FIG. 1). Moreover, the heated vapor 220 may transfer thermal energy to the coatings 138 at a relatively high rate. As a result, the web 106 can be moved through the reflow chamber 130 at a rate that is at least as great as the rate at which the web 106 moves through the other stations 112, 114, 128 (shown in FIG. 1) of the system 100 (shown in FIG. 1). Additionally, because the reflow chamber 130 heats the conductive coatings 138 in a continuous rather than batch manner in one embodiment, the reflow chamber 130 continually heats the web 106.

In order to prevent contamination of the conductive coatings 138 (shown in FIG. 1) and to more evenly heat the coatings 138, liquid or condensation on the web 106 is removed from the web 106 prior to introducing the web 106 into the interior chamber 204 in one embodiment. For example, the pathway 134 may pass through a cooling block 252 that rapidly cools the surrounding area of the inlet. The cooling block 252 includes a water cooled copper block that extends around the inlet port 206 in one embodiment. Alternatively, the cooling block 252 removes condensation from the web 106 by blowing air across the web 106.

The reflow chamber 130 includes a cooling block 228 at or near the outlet port 208 in the illustrated embodiment. The cooling block 228 may be similar to the cooling block 252 at the inlet port 206. The cooling block 228 rapidly cools the surrounding area of outlet and the web 106 after the web 106 has passed through the heated and saturated vapor 220 in the interior chamber 204. The cooling of the web 106 may solidify the coatings 138 and/or condense excess vapor 220 on the exterior surfaces of the plated electrical components 136 (shown in FIG. 1) and create condensation 230. The outlet port 208 may have a lower surface 232 that is angled or pitched towards the interior chamber 204. The condensation 230 drips or falls off of the web 106 onto the lower surface 232 and flows back into the interior chamber 204. The cooling block 252 that is located proximate to the inlet port 206 may include a similar lower surface 234. Heated vapor 220 that enters into the inlet port 206 may be cooled by the cooling block 252 before the heated vapor 220 is able to exit the reflow chamber 130. The cooled vapor 220 condenses as condensation 230 and drips back into the interior chamber 204 via the surface 234. The condensation 230 may be re-used to generate additional heated vapor 220. For example, the condensation 230 may be at least partially recycled by flowing from the inlet and outlet ports 206, 208 into the liquid reservoir 224, where the condensation 230 is heated by the heating elements 226 to create additional heated vapor 220. In another embodiment, one or more of the inlet and outlet ports 206, 208 includes a drain similar to the drain 242 described below that collects and directs the condensation 230 into an exterior reservoir (not shown) or back into the interior chamber 204. The collected condensation 230 may then be re-introduced into the interior chamber 204.

The reflow chamber 130 includes a reclamation reservoir 236 disposed along the pathway 134 downstream from the outlet port 208 in the illustrated embodiment. The reclamation reservoir 236 obtains condensation 230 of the vapor 220 that exits the interior chamber 204 on the web 106. An air source 238 forces air 240 across the web 106 and the plated electrical components 138 (shown in FIG. 1) to force the condensation 230 off of the web 106 and components 138. The condensation 230 is collected into the reclamation reservoir 236. The reclamation reservoir 236 includes the drain 242 that is fluidly connected with the interior chamber 204 via a conduit 244. The condensation 230 flows into the interior chamber 204 through the drain 242 and the conduit 244. The condensation 230 may be heated by the heating elements 226 to generate additional heated vapor 220.

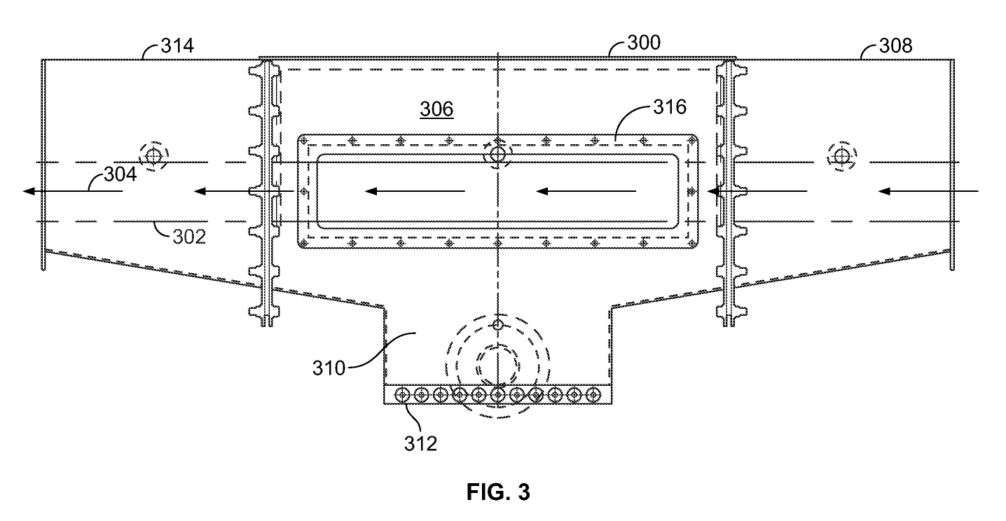

FIG. 3 is an elevational view of a vapor phase reflow chamber 300 formed in accordance with another embodiment. The reflow chamber 300 is similar to the reflow chamber 130 described above and shown in FIG. 1. The web 106 (shown in FIG. 1) passes through the reflow chamber 300 along a processing pathway 302 that is similar to the processing pathway 134 (shown in FIG. 1). The web 106 proceeds along the pathway 302 in a direction indicated by arrows 304. An inlet port 308 similar to the inlet port 206 (shown in FIG. 1) receives the web 106. The web 106 passes through an interior chamber 306 similar to the chamber 204 (shown in FIG. 2) where the conductive coatings 138 (shown in FIG. 1) on the plated electrical components 136 (shown in FIG. 1) are heated and reflow. The web 106 exits the interior chamber 306 through an outlet port 314 that is similar to the outlet port 208 (shown in FIG. 2).

The interior chamber 306 houses a heated and saturated vapor that is similar to the vapor 220 (shown in FIG. 2). The conductive coatings 138 (shown in FIG. 1) on the plated electrical components 136 (shown in FIG. 1) are heated and reflow by the heated and saturated vapor, similar to as described above. The heated and saturated vapor may be generated by heating liquid in a liquid reservoir 310 similar to the reservoir 224 (shown in FIG. 2) in the interior chamber 306. Heating elements 312 similar to the heating elements 226 heat the liquid to generate the heated and saturated vapor. The reflow chamber 300 includes a window 316 through which an operator can view the interior chamber 306. The operator may check on the progress of the web 106 through the interior chamber 306 and on the amount of liquid in the liquid reservoir 310 using the window 316, for example.

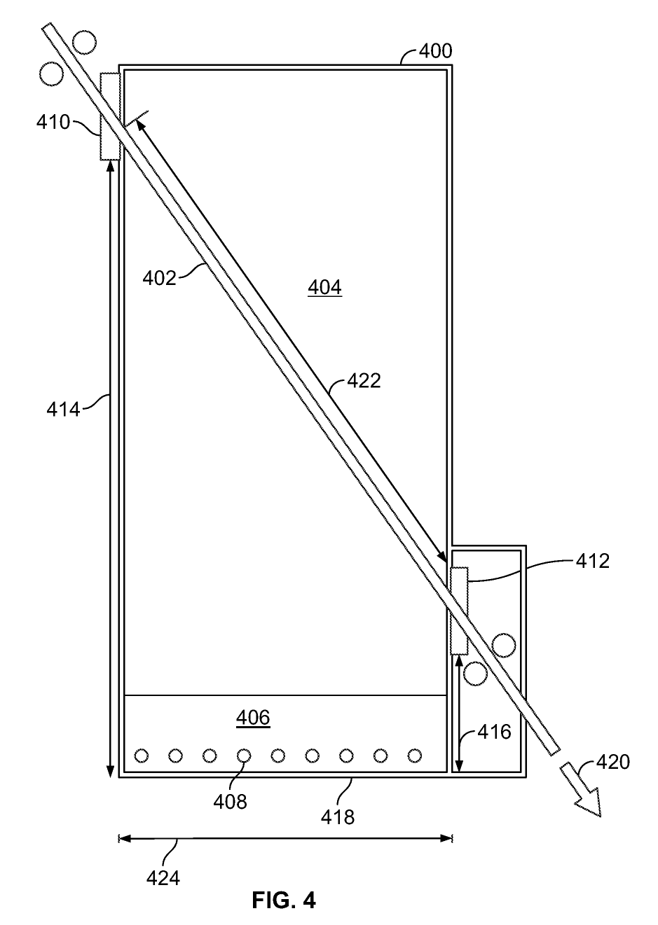

FIG. 4 is a schematic view of a vapor phase reflow chamber 400 implemented in accordance with another embodiment. The reflow chamber 400 operates in a manner similar to the reflow chamber 130 (shown in FIG. 1) described above. For example, a web 402 of interconnected electrical components coated with a conductive coating may enter into the reflow chamber 400 through an inlet port 410, pass through an interior chamber 404 and exit the reflow chamber 400 through an outlet port 412, similar to as described above in connection with the reflow chamber 130. The interior chamber 404 of the reflow chamber 400 includes a heated and saturated vapor that heats the conductive coating on the electrical components to reflow the coating about the components. The heated vapor may be created by heating liquid in a reservoir 406 in the interior chamber 404 using heating elements 408, similar to as described above in connection with the reflow chamber 130.

One difference between the reflow chamber 400 and the reflow chamber 130 (shown in FIG. 1) is the relative locations of the inlet and outlet ports 410, 412. The inlet and outlet ports 410, 412 are separated by a separation distance 424 that is measured along a bottom side 418 of the reflow chamber 400. As described above, the inlet and outlet ports 206, 208 (shown in FIG. 2) of the reflow chamber 130 are disposed at approximately the same height 214 (shown in FIG. 2) in the interior chamber 204 (shown in FIG. 2) of the reflow chamber 130. In contrast, the inlet and outlet ports 410, 412 are disposed at different heights 414, 416 above a bottom side 418 of the reflow chamber 130. The height 414 of the inlet port 410 is greater than the height 416 of the outlet port 412 such that the web 402 proceeds through the reflow chamber 400 in a downward angled path generally denoted by the arrow 420. Alternatively, the height 416 of the outlet port 412 may be greater than the height 414 of the inlet port 410.

Disposing the inlet and outlet ports 410, 412 at different heights 414, 416 or otherwise passing the web 402 through the interior chamber 404 at an angle with respect to the bottom side 418 of the chamber 400 increases a section length 422 of the web 402 that is located in the interior chamber 404 as the web 402 passes through the reflow chamber 400. For example, if the separation distance 424 of the inlet and outlet ports 410, 412 is approximately the same as the separation distance 248 (shown in FIG. 2) of the reflow chamber 130 and the webs 402, 106 (shown in FIG. 1) are moved through the interior chambers 404, 204 (shown in FIG. 2) at approximately the same speed, the time that the conductive coatings and electrical components are heated in the interior chambers 404, 204 is greater in the reflow chamber 400 than the reflow chamber 130. For example, the dwell time for each electrical component may be increased in the reflow chamber 400 because the electrical component must travel a greater distance in the interior chamber 404 of the reflow chamber 400 than the interior chamber 204 of the reflow chamber 130. Increased dwell times may be desired in manufacturing systems such as the system 100 (shown in FIG. 1) where the time require to reflow the conductive coatings must be increased due to the relatively rapid speed at which the web 402 moves through the system 100.

FIG. 6 is a flowchart of a method 500 for reflowing a conductive coating on formed electrical components according to one embodiment. The method 500 may be used to reflow a conductive coating about one or more electrical components using vapor phase reflow. For example, the method 500 may be used to heat and reflow the conductive coating 138 (shown in FIG. 1) about the formed electrical components 136 (shown in FIG. 1) that are interconnected with one another in the web 106 (shown in FIG. 1). At 502, a web of stock material is provided. For example, the stock material 104 may be provided to move along the predetermined processing pathway 134 (shown in FIG. 1). At 504, the stock material is machined into blanked components. For example, the stock material 104 may be machined into the blanked components 116 (shown in FIG. 1). Alternatively, the stock material 104 may be drawn or extended into an elongated wire as the blanked components 116.

At 506, the blanked components are formed into formed electrical components. For example, the blanked components 116 (shown in FIG. 1) may be bent into the formed electrical components 124 (shown in FIG. 1). At 508, the formed electrical components are coated or plated with a conductive coating. As described above, the formed electrical components 124 may be coated with a conductive coating 138 (shown in FIG. 1) to create plated electrical components 136 (shown in FIG. 1).

At 510, the web is moved through a reflow chamber in a continuous manner. The web 106 (shown in FIG. 1) may be passed along the processing pathway 134 (shown in FIG. 1) and through the reflow chamber 130 (shown in FIG. 1). The web 106 is moved through the reflow chamber 130 such that less than the entire length 118 (shown in FIG. 1) of the web 106 is located within the chamber 130 at a given time and the web 106 is continually moved through the reflow chamber 130 such that the entire length 118 of the web 106 eventually passes through the reflow chamber 130.

At 512, the conductive coatings on the electrical components are heated by a vapor in the reflow chamber. For example, the conductive coatings 138 (shown in FIG. 1) on the formed electrical components 136 (shown in FIG. 1) may be heated by a heated and saturated vapor 220 (shown in FIG. 2) in the reflow chamber 130 (shown in FIG. 1). As a result, the conductive coatings reflow about the exterior of the electrical components, as described above. The conductive coatings are heated as the electrical components pass through the reflow chamber. Thus, the operations described in connection with 510 and 512 may occur concurrently, with less than all of the electrical components interconnected in the web being heated in the reflow chamber at a given time. As described above, the web 106 (shown in FIG. 1) may be continually moved through the reflow chamber 130 in order to heat and reflow the conductive coatings 138 on the electrical components 136 of the web 106.

In accordance with one or more embodiments described above, systems and methods are provided for reflowing conductive coatings on formed electrical components that are interconnected in a continuous web. The coatings and components are passed through a heated and saturated vapor in a reflow chamber in a continuous manner. While in the reflow chamber, the heated and saturated vapor rapidly and evenly heats the conductive coatings to reflow the coatings about the exterior of the electrical components. The continuous manner of reflowing the conductive coatings permits the reflow chamber to be placed in-line with a manufacturing process.

Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 1102, sixth paragraph, unless and until such claim limitations expressly use the phrase “means for” followed by a statement of function void of further structure.

What is claimed is:

1. A system for manufacturing electrical components, the system comprising:
a reflow chamber having an inlet port and an outlet port, the inlet port receiving a web of interconnected electrical components having a conductive coating into the reflow chamber, the outlet port discharging the web from the reflow chamber, the reflow chamber directing the web of interconnected electrical components along a predetermined pathway through the reflow chamber, wherein the reflow chamber is configured to retain a heated and saturated vapor to heat the conductive coating as the web passes along the pathway through the chamber to reflow the conductive coating about the electrical components.

2. The system of claim 1, wherein the reflow chamber is configured to pass a continuous web of the electrical components through the reflow chamber to reflow the conductive coating.

3. The system of claim 1, wherein the conductive coating comprises at least one of tin and a tin alloy.

4. The system of claim 1, wherein the heated and saturated vapor is an inert gas.

5. The system of claim 1, wherein at least one of the inlet and outlet ports comprises a cooling element configured to condense the heated vapor and prevent the heated vapor from escaping from the reflow chamber.

6. The system of claim 1, further comprising a heating element in the reflow chamber, wherein the reflow chamber is shaped to collect condensation of the heated vapor and the heating element is configured to heat the condensation to generate additional heated vapor.

7. The system of claim 1, further comprising a plating station configured to provide the conductive coating on the electrical components prior to passing the electrical components through the reflow chamber.

8. The system of claim 1, wherein the conductive coating comprises at least one of zinc and a zinc alloy.

9. The system of claim 1, wherein the reflow chamber converts the conductive coating on the electrical components from a plated state to a reflowed state.

10. A method for manufacturing electrical components, the method comprising:
passing a continuous web of interconnected electrical components through a reflow chamber, the electrical components having a conductive coating; and
heating the conductive coating in the reflow chamber with a heated and saturated vapor to reflow the conductive coating about the electrical components.

11. The method of claim 10, wherein the passing operation moves the web along a predetermined pathway through the reflow chamber such that a downstream section of the web is removed from the reflow chamber prior to introducing an upstream section of the web into the reflow chamber.

12. The method of claim 10, further comprising collecting condensation of the heated vapor on the web and heating the condensation to provide additional heated vapor in the reflow chamber.

13. The method of claim 10, wherein the web comprises at least one of electrical contacts interconnected by a carrier strip.

14. The method of claim 10, further comprising cooling the heated vapor at one or more ports of the reflow chamber to condense the vapor and prevent the vapor from discharging from the reflow chamber.

15. A method for manufacturing electrical components, the method comprising:
providing a web of interconnected electrical components having a conductive coating;
moving the web through a reflow chamber; and
heating the conductive coating on the electrical components in the reflow chamber using a heated and saturated vapor to reflow the conductive coating about the electrical components.

16. The method of claim 15, wherein the heating operation comprises heating the conductive coating in the reflow chamber as the web moves through the reflow chamber.

17. The method of claim 15, wherein the moving operation comprises passing the web into the reflow chamber through an inlet port and out of the reflow chamber through an outlet port, wherein the web is passed along an indirect route between the inlet port and outlet port within the reflow chamber.

18. The method of claim 15, further comprising cooling the conductive coating after the web passes through the reflow chamber to at least one of remove vapor condensation from the web and solidify the conductive coating.

19. The method of claim 15, further comprising collecting condensation of the vapor from the web and heating the condensation to provide additional heated vapor in the reflow chamber.

20. The method of claim 15, wherein the heating operation reflows the conductive coating to convert the coating from a plated state to a reflowed state.
